(19) United States
(12) Patent Application Publication
(10) Pub. No.: US 2024/0288857 A1
(43) Pub. Date: Aug. 29, 2024

(54) METHOD FOR DETERMINING PROCESS PARAMETERS FOR A MANUFACTURING PROCESS OF A REAL PRODUCT

(71) Applicant: Volkswagen Aktiengesellschaft, Wolfsburg (DE)

(72) Inventors: Erik ROHKOHL, Wolfenbuettel (DE); Mathias KRAKEN, Braunschweig (DE); Malte SCHOENEMANN, Braunschweig (DE)

(73) Assignee: Volkswagen Aktiengesellschaft, Wolfsburg (DE)

(21) Appl. No.: 18/656,483

(22) Filed: May 6, 2024

Related U.S. Application Data
(63) Continuation of application No. PCT/EP2022/080781, filed on Nov. 4, 2022.

(30) Foreign Application Priority Data
Nov. 4, 2021 (DE) 10 2021 128 718.9

(51) Int. Cl. G05B 19/418; G05B 17/02; H01M 10/04

(52) U.S. Cl. CPC G05B 19/41885; G05B 17/02; G05B 19/41815; H01M 10/0404; G05B 2219/31343

(57) ABSTRACT

A method for determining process parameters for a manufacturing process of a real product. The manufacturing process includes at least one operation of a real device with at least one process parameter. The real device is provided as a virtual device. A setpoint value of the at least one process parameter is provided. The setpoint value is analyzed and an expected actual value is generated of the process parameter which actually occurs during operation of the real device. The expected actual value is determined taking into account influencing parameters, with the expected actual value deviating from the setpoint value or comprising a set of values with a plurality of values. The virtual device is operated with the at least one process parameter as part of a simulation, wherein at least the actual value to be expected is used.

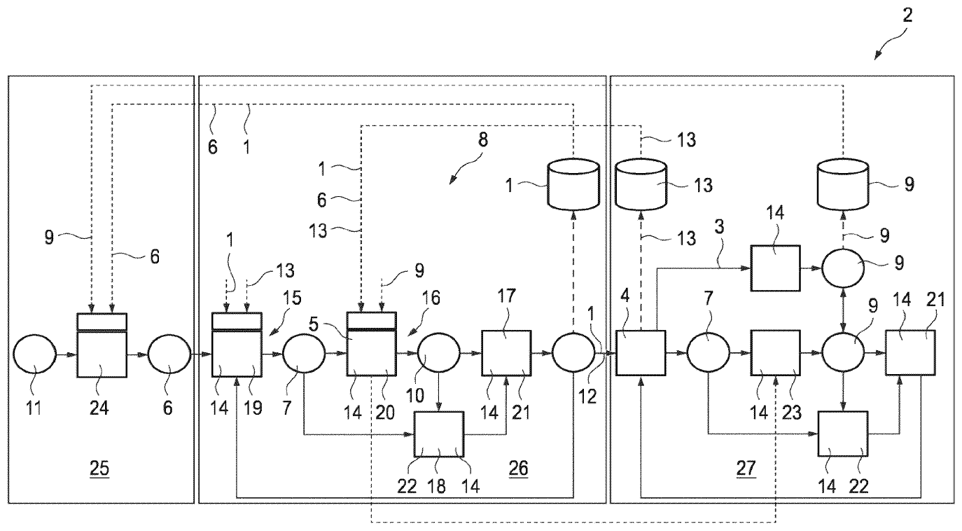

This nonprovisional application is a continuation of International Application No. PCT/EP2022/080781, which was filed on Nov. 4, 2022, and which claims priority to German Patent Application No. 10 2021 128 718.9, which was filed in Germany on Nov. 4, 2021, and which are both herein incorporated by reference.

### BACKGROUND OF THE INVENTION

### Field of the Invention

The invention relates to a method for determining process parameters for a manufacturing process of a real product, in particular for the manufacturing process of at least one component of a battery cell.

### Description of the Background Art

Batteries, in particular lithium-ion batteries, are increasingly being used to power motor vehicles. In particular, for example, a motor vehicle has an electrical machine for driving the vehicle, whereby the electrical machine can be driven by the electrical energy stored in the battery cell. Batteries are usually composed of battery cells, with each battery cell having a stack of anode layers, cathode layers and separator layers. At least some of the anode layers and cathode layers are designed as current arresters to conduct the current provided by the battery cell to a consumer located outside the battery cell. Battery cells with liquid or solid electrolytes (solid-state battery) are known.

In particular, a battery cell has a housing, which is preferably gas-tight, and at least one stack of electrode foils or electrode layers arranged on top of each other. The housing can be designed as a rigid housing (e.g. as a prismatic cell or round cell) or at least partially made of an elastically deformable foil material (pouch cell). A combination of both types of housing is also possible.

When manufacturing an electrode of a battery cell, a so-called carrier material, in particular a strip-shaped carrier material, e.g. a carrier film, is at least partially coated on one or both sides with an active material. The current arresters (arrester flags) formed on the electrode are formed in particular by uncoated areas of the carrier material. The carrier material comprises, for example, copper, a copper alloy, aluminum or an aluminum alloy.

To produce the battery cell, the electrodes are stacked, with different electrodes (anodes and cathodes) separated from each other by separator materials. A stack produced in this way is placed in the housing, which is then sealed and, if necessary, filled with an electrolyte.

The production of battery cells causes high manufacturing costs, a large amount of material waste and environmentally harmful emissions. Vehicle manufacturers in particular will generate a high demand for battery cells in the future, meaning that a large number of factories will have to be operated for the production of battery cells. There is therefore a need to develop suitable production technologies and to find and exploit optimization potential for the economic and ecological effects.

Various continuous manufacturing processes (e.g. for mixing, coating, calendering) are used in the production of battery cells and especially in the production of electrodes. A continuous manufacturing process comprises several manufacturing steps that are interlinked and therefore cannot be carried out independently of each other. For example, when manufacturing the electrodes, the active material must be mixed and then applied directly to a carrier material and immediately afterwards calendered (i.e. compacted) and, if necessary, dried.

The systems for such continuous manufacturing processes or production methods are often complex systems with a large number of adjustable operating parameters and measured variables to be recorded. This complexity of continuous manufacturing processes makes the targeted production of desired product properties and the simultaneous minimization of manufacturing costs and environmental effects/impact difficult.

It is therefore necessary to use methodical support for the definition of initial process parameters as well as for the monitoring and adaptive or, if necessary, continuous or iterative control of the manufacturing processes. This is the only way to ensure that product quality is achieved despite a wide range of disturbance variables and that costs and environmental effects are minimized at the same time.

Previous methods for controlling or setting up such manufacturing processes do not include, for example, optimization according to ecological and economic objectives, only according to product quality (i.e. the conformity of the required product characteristics with the produced product characteristics), are not suitable for continuous processes in battery cell production, as models do not describe time dependencies, do not enable real-time monitoring and real-time control of product quality, manufacturing costs and environmental effects in manufacturing, or do not include transfer learning from process development to large-scale series production, especially not for continuous processes.

So far, attempts have been made to solve the above-mentioned problems, for example as follows: with a manual process development comprising numerous experiments to find an optimal parameter set that meets product quality and manufacturing cost requirements; by checking the consistency of developed process parameters through selective iterative measurements during the manufacturing process; by manually adjusting the process parameters, if necessary, if produced product properties are no longer within the defined tolerance range.

It has not yet been possible to take economic and ecological influences into account, as methodological support has not yet been proposed.

EP 3 525 049 A1 describes a method for determining the status data of a production system. A model of the production system with virtual workstations is created and a virtual workflow is simulated. Simulated sensor data is used for this. Status data of the production system is formed on the basis of this simulated sensor data.

WO 2021/043712 A1, which corresponds to US 2022/0327457, is directed to a computer-implemented method for designing a production process. A production model is provided that specifies mathematical relationships between process simulation results and the process settings. An optimal configuration of the production process is determined in which the useful life of the respective system component is maximized.

DE 10 2018 220 064 A1, which is herein incorporated by reference, is directed to a method for determining values of production parameters of a production process. An input variable of the production parameters is determined from a product property by means of an inverse model.

### SUMMARY OF THE INVENTION

It is therefore an object of the present invention to at least partially solve the problems cited with reference to the prior art. In particular, a method for determining process parameters for a manufacturing process of a real product, in particular for the manufacturing process of at least one component of a battery cell, is to be proposed. In particular, the proposed method is intended to prepare a manufacturing process of the real product by simulating a manufacturing process of a virtual product.

An exemplary method for determining process parameters for a manufacturing process of a real product is therefore provided. The manufacturing process comprises at least one operation of a real device with at least one process parameter. The method comprises at least the following steps: (a) providing the real device as a virtual device; (b) providing a setpoint value of the at least one process parameter; and analyzing the setpoint value and generating an expected actual value of the process parameter which actually occurs during operation of the real device, the expected actual value being determined taking into account influencing parameters; (c) the expected actual value deviating from the setpoint value or comprising a set of values with a plurality of values; and (d) operating the virtual device with the at least one process parameter as part of a simulation, using at least the expected actual value.

The above (non-exhaustive) classification of the process steps into a) to d) is primarily only intended to serve as a differentiation and not to enforce any sequence and/or dependency. The frequency of the process steps, e.g. during the execution of the process, can also vary. It is also possible for process steps to at least partially overlap in time. It is particularly preferred that process steps a) to c) take place before step d). In particular, step c) takes place after step b). In particular, steps a) to d) take place at least partially parallel to one another. In particular, steps a) to d) are carried out in the specified order.

A real product is, for example, a known component of a battery cell, e.g. an electrode comprising a coated carrier material or a stack of electrodes formed by stacked electrodes and separator materials. The real product is actually physically present and can be used, for example, to power motor vehicles.

A basically known manufacturing process for the real product comprises in particular the steps and devices required to manufacture the product. To manufacture an electrode, it is necessary, for example, to provide the carrier material as a coil, a device for continuously unrolling the carrier material from the coil, further devices for mixing and providing the coating of the carrier material, for applying the coating to the carrier material, for calendering the coating, for drying the calendered coating, for cutting to length and trimming the possibly coated carrier material and for depositing the electrodes.

Such real, i.e. physically present, devices are referred to here as real devices. These devices are operated with at least one process parameter (or a plurality of different process parameters) during operation of the real device, i.e. as part of the manufacturing process of the real product. For example, a device for unrolling the carrier material is operated at a certain speed and possibly with certain contact pressure forces as process parameters. A device for mixing is operated, for example, in such a way that certain mixing ratios, temperatures, aggregate states, pressures, densities, etc. of the individual components of the mixture are maintained as process parameters. A device for applying the coating is operated in a controlled manner, e.g. with regard to the feed rate of the carrier material, the properties of the coating material, the throughput of coating material, etc. A calender is operated in a controlled manner, e.g. with regard to the feed rate of the coated substrate material, the properties of the coating, etc. In particular, all parameters that can be controlled, adjusted or influenced by a user or operator are therefore regarded as process parameters.

The steps a) to d) listed above comprise in particular only a section of the manufacturing process that is required to manufacture a real product and which is also described in more detail below.

As part of step a), the real device is provided as a virtual device. The device to be used or used to manufacture the real product is therefore simulated by a virtual, i.e. non-physical, device. This virtual device can, for example, be generated by a data processing system and operated as part of a simulation (see step d)).

As part of step b), a setpoint value of the at least one process parameter is provided in particular. This setpoint value is derived in particular from empirical values. Empirical values include, for example, empirically determined values that are known, for example, from the previous operation of comparable devices. Alternatively, the setpoint value can also be formed by a freely determined, i.e. estimated, value. The setpoint value of the process parameter is in particular the value with which the device is to be operated. This is set, for example, on the real device as part of the manufacturing process for the real product.

As part of step c), the setpoint value is analyzed and an expected actual value of the process parameter is generated, which actually occurs during operation of the real device. This takes into account the fact that a setpoint value set on a real device is not actually realized by the device in the vast majority of cases. For example, a setpoint value for a rotational speed of the device can be set, but the actual rotational speed of the device will usually deviate from this setpoint value, e.g. by a constant difference. However, the actual rotational speed may also vary (e.g. oscillate around a constant mean value) or change over time (the mean value or the constant rotational speed may change without changing the set setpoint value).

The setpoint value can be analyzed, for example, by a data processing system. In particular, the expected actual value can be derived from empirical values. Empirical values include, for example, empirically determined values that are known, for example, from the previous operation of comparable devices.

The actual value to be expected is determined taking into account influencing parameters. Such influencing parameters are, for example, environmental conditions (e.g. temperature, humidity, pressure) of the actual device, age or operating time of the actual device, etc.

The expected actual value deviates from the setpoint value or comprises a set of values with a plurality of values. If necessary, a fixed deviation of the expected actual value from the setpoint value is calculated, e.g. if the actual speed of the device always deviates from the setpoint speed by a known value. Alternatively or additionally, when determining the expected actual value, it can be taken into account that the deviation varies or is within a certain interval that may change over time. In this case, the expected actual value comprises a set of values with a plurality of (different) values.

In step d), the virtual device is operated with the at least one process parameter as part of a simulation. The simulation is carried out in particular by a data processing system.

In particular, at least the expected actual value is used. In the simulation, the virtual device is therefore not operated with the setpoint value, but a deviation from the setpoint value that occurs in most cases and that is actually present or can be present on a real device is taken into account.

The simulation therefore takes into account these usual, but previously unconsidered deviations from setpoint values that exist or can occur on real devices.

With the proposed method, a more robust simulation of the real manufacturing process can be achieved. In particular, instabilities can occur with the selected setpoint values due to the actual values occurring on the real device, which can only be detected when this possible deviation from the setpoint value is taken into account. These instabilities can then be reduced or avoided by selecting other, i.e. changed, setpoint values.

In particular, in a further step e1), a product property of a virtual product produced by the simulation that is influenced by the at least one process parameter is determined. If a deviation of the product property from a desired product property is determined, at least steps b) to d) and e1) are repeated at least once with a modified setpoint value.

A product property is in particular a property of the (virtually or real) manufactured or existing product, e.g. a geometric property (dimensional accuracy, thickness, length, width, etc.), a physical property (density, porosity, mixing ratio, distribution of different materials, electrical conductivity, etc.), a chemical property (reactivity, chemical stability, etc.).

Step e1) is carried out in particular after steps a) to d). Step e1) can represent the condition that at least steps b) to d) are carried out repeatedly with the at least one changed setpoint value. According to step c), a new expected actual value is then also generated during the repeated execution.

In particular, steps b) to d) and e1) can be carried out as often as necessary until the product property determined in step e1) corresponds to the desired product property (or lies within its tolerance field).

In a further step e2), in particular as part of the simulation, i.e. the operation of the virtual device, an assessment is made of the manufacturing costs of the real product and/or of the environmental effects/impact that (would) result from the manufacture of the real product. To minimize the manufacturing costs and/or the environmental effect, at least steps b) to d) and e2) are repeated at least once with a modified setpoint value.

In particular, step e2) is carried out after steps a) to d), possibly before, after or simultaneously with step e1). Step e2) can represent the condition that at least steps b) to d) are carried out repeatedly with the at least one changed setpoint value. According to step c), a new expected actual value is then also generated during the repeated execution.

In particular, steps b) to d) and e2) can be carried out as often as necessary until the manufacturing costs of the real product and/or the environmental effects evaluated in step e2) reach an acceptable or minimum value.

Manufacturing costs are considered to be, in particular, the costs of manufacturing the real product that can be assessed in monetary terms. Environmental effects are, for example, all factors that have a negative or positive influence on ecological aspects, e.g. toxicity of substances used or produced in the manufacture of the product, CO₂ generation or energy consumption of the manufacturing process, space requirements of the manufacturing process, etc.

In particular, steps e1) and e2) can be carried out with mutual consideration, i.e. process steps are repeated until satisfactory values are achieved for all the factors mentioned (i.e. product properties, manufacturing costs, environmental impact).

In particular, a result for the setpoint value is determined in step f) in which at least the deviation of the product property determined in step e1) or the manufacturing costs and/or environmental impact determined in step e2) are minimized. In particular, this result is used to operate the real device.

In particular, step f) represents the conclusion of the method according to steps a) to d) and, if applicable, e1) and/or e2). Step f) is therefore carried out in particular after steps a) to d) and e1) and e2).

In particular, the operation of the real device is monitored at least temporarily, whereby the setpoint value used during operation and at least the actual value that is present on the real device or a product property of the manufactured real product or the manufacturing costs of the real product and/or the environmental effects caused by the manufacture of the real product is recorded.

The explanations for steps a) to d), e1), e2) and f) apply equally here. In particular, the simulation of the manufacture of the product, i.e. the virtual manufacturing process and the virtually manufactured product, can be validated, checked and, if necessary, improved by operating the real device. In particular, the operating parameters recorded during operation of the real device are compared with the process parameters of the virtual manufacturing process, the expected actual values, the product properties of the virtual product and the manufacturing costs of the virtual product determined during the simulation and/or the environmental impact caused by the manufacture of the real product. From the comparison, the input variables used for the simulation can be validated, i.e. checked, and changed if necessary.

In particular, the real operation is adjusted continuously or at intervals on the basis of the operating parameters recorded. The real operation can therefore be changed at any time, i.e. even during the ongoing manufacturing process.

In particular, at least one of the recorded operating parameters is taken into account continuously or at intervals for the operation of the virtual device. In particular, the operating parameters recorded can be used to run a further simulation again, so that the results of this further simulation can then be used for real operation.

In particular, the real device is an experimental device and the result of the operation of this experimental device is used to operate a real series device. In particular, a smaller number of operating parameters are recorded during the operation of the series device than during the operation of the experimental device. In particular, the operation of the series device is adapted continuously or at intervals, at least also on the basis of the operating parameters recorded on the experimental device.

A series device differs from an experimental device in particular (also) in that the number of products that can be manufactured per time is significantly greater, e.g. by a factor of at least 10, preferably at least 100.

In particular, the manufacturing process comprises a large number of successive manufacturing steps carried out on different devices, at least some of the manufacturing steps being carried out as part of continuous manufacturing.

Continuous manufacturing can mean, for example, that the individual devices of this production system cannot be operated individually, but only in combination. For example, in an electrode manufacturing process, a carrier material is provided and coated as a continuous material. The devices for providing and conveying the carrier material and the devices for preparing the coating, for coating, for drying the applied coating and for calendering as well as the device for trimming the continuous material can only be operated together.

In particular, the real product is at least one component of a battery cell and the device is designed to be suitable for producing at least this component.

A battery cell, possibly ASS (all solid state), is further proposed, at least comprising as components of the battery cell a housing and a stack of electrodes arranged therein. In particular, the battery cell comprises a liquid or so-called solid electrolyte. At least one component of the battery cell is produced by the method described or using the method described.

The battery cell is in particular a pouch cell (with a deformable battery cell housing formed of a pouch foil) or a prismatic cell or a round cell (each with a dimensionally stable battery cell housing). A pouch foil is a known deformable housing part that is used as a battery cell housing for so-called pouch cells. It is a composite material, e.g. comprising a plastic and aluminum.

The battery cell can be a lithium-ion battery cell or another type of battery cell.

A battery cell can be a power storage device that is used, for example, in a motor vehicle to store electrical energy. In particular, for example, a motor vehicle has an electric machine for driving the motor vehicle (a traction drive), whereby the electric machine can be driven by the electric energy stored in the battery cell.

A motor vehicle is further proposed, at least comprising a traction drive and a battery with at least one of the battery cells described, wherein the traction drive can be supplied with energy by the at least one battery cell.

In particular, a system for data processing is proposed which has components which are suitably equipped, configured or programmed to carry out the method or which carry out the method.

The components comprise, for example, a processor and a memory in which instructions to be executed by the processor are stored, as well as data lines or transmission devices which enable the transmission of instructions, measured values, data or the like between the aforementioned elements.

There is further proposed a computer program comprising instructions which, when the program is executed by a computer, cause the computer to carry out the described method or the steps of the described method.

A computer-readable storage medium is further proposed, comprising instructions which, when executed by a computer, cause the computer to carry out the described method or the steps of the described method.

The explanations regarding the method are in particular applicable to the system for data processing and/or the computer-implemented method (i.e. the computer program and the computer-readable storage medium) as well as the battery cell and the motor vehicle and vice versa.

In particular, the proposed method supports the development of such product manufacturing processes by intelligently deriving potentially particularly suitable or optimal process parameters based on empirical knowledge. Furthermore, these process parameters can be validated and automatically adapted in a virtual environment (i.e. the simulation) using artificial intelligence (e.g. the data processing system). Ultimately, the proposed method ensures the consistency of developed process parameters in large-scale production through continuous monitoring and inline-capable control.

As part of the method, artificial intelligence in particular is developed and linked together. A so-called recipe manager is used to derive and provide suitable setpoint values for the process parameters as part of step b). A so-called digital twin of the at least one real device is used to analyze the setpoint value and to generate an expected actual value of the process parameter in accordance with step c). Furthermore, a (first) process model of the real device, i.e. a virtual device, is provided so that it is possible to operate the virtual device with the at least one process parameter as part of a simulation of actual parameters. This allows product properties of a virtually manufactured product to be determined as part of step e1). In particular, a controller (a control unit) can also be provided for controlling manufacturing processes, including continuous ones, in particular in real time, and a cost model for evaluating ecological and economic objectives. The combination of these concepts allows virtual process development and automated improvement or optimization of ecological and/or economic goals. The consistency of the optimized manufacturing process is ensured in the production of the real product by a pre-trained (second) process model and a controller. The (second) process model is integrated by means of transfer learning from process development (i.e. from the simulation) into production or large-scale series production (i.e. the operation of the series device).

In process development, specified product and intermediate product properties in particular are transferred into a corresponding set of setpoint process parameters that produce them as robustly, cost-effectively and sustainably as possible. Based on (personal) experience, empirical knowledge and formal documentation, an initial set of parameters, at least one setpoint value, is derived during process development, which presumably fulfills the product requirements (step b) of the method).

The so-called recipe manager supports the user in particular in transferring product properties into a set of setpoint parameters. With the help of a so-called digital twin, it is possible to estimate the distribution of the corresponding actual parameters on the real device (step c) of the method).

In particular, the expected actual values are virtually transferred from the process model (i.e. as part of the simulation) into corresponding product properties that allow a comparison with the specification (steps d) and e1) of the method).

In particular, the cost model can calculate the manufacturing costs using an analytical function and quantify the environmental effects (e.g. CO₂ equivalents in kg) (step e2) of the method).

On this basis, the controller can in particular calculate improved setpoint values for the process parameters (step e1) and/or e2) of the method). These can then be transferred back to the digital twin and iteratively improved until no significant improvement in quality or product properties and/or manufacturing costs is achieved, i.e. until the results of the setpoint values according to step f) of the method are available.

Improved or optimized setpoint values of the process parameters can be transferred from the virtual process development to a physical system, i.e. to a real device, e.g. in battery cell production. In particular, the digital twin is replaced by a real system which, in addition to the product, continuously generates/records the actual parameters present on the real device.

If the product properties cannot be measured inline, the process model in particular allows their continuous prediction. The process model can be integrated into the real production environment, in particular by means of Transfer Learning, so that it maps the system-specific properties. To do this, the process model is pre-trained during process development on a specific system, i.e. the test device (possibly in the laboratory/technical center) and then fine-tuned with new data from production. This can be done either with a reduced learning rate or with partially fixed model parameters.

The estimated product properties of the process model and the evaluated manufacturing costs of measured setpoint parameters are used by the controller in particular for adaptive control of the real manufacturing process and for automated minimization of manufacturing costs.

With an additional, so-called atline analysis (which therefore takes place on the real device in the real manufacturing process), the product properties of continuously manufactured products can be quantified and the prediction of the process model validated, particularly iteratively. Furthermore, training data can be generated continuously and iteratively to improve the simulation (of the process model).

As a precaution, it should be noted that the number words used here (“first”, “second”, . . . ) are primarily (only) used to distinguish between several similar objects, quantities or processes, i.e. in particular they do not necessarily specify any dependency and/or sequence of these objects, quantities or processes in relation to one another. If a dependency and/or sequence is required, this is explicitly stated here or is obvious to the person skilled in the art when studying the specific embodiment described. Insofar as a component may occur more than once (“at least one”), the description of one of these components may apply equally to all or some of the plurality of these components, but this is not mandatory.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawings which are given by way of illustration only, and thus, are not limitive of the present invention, and wherein the sole FIGURE shows the manufacturing process of a real product.

### DETAILED DESCRIPTION

In the drawings, the FIGURES shows the manufacturing process 2 of a real product 3. In particular, the manufacturing process 2 is divided into three sections. In the first section 25, available knowledge is used. In the second section 26, the manufacturing process 2 of a real product 3 is simulated as part of a simulation 8. In a third section 27, the real product 3 is manufactured.

In step a), the real device 4 is provided as a virtual device 5. The device 4 to be used or used to manufacture the real product 3 is thus simulated by a virtual, i.e. non-physical, device 5. This virtual device 5 is generated by a system 14 for data processing and operated as part of a simulation 8 (see step d) 16).

In step b), a setpoint value 6 of the at least one process parameter 1 is provided. This setpoint value 6 is derived from empirical values. Alternatively, the setpoint 6 can also be formed by a freely determined, i.e. estimated, value. The setpoint 6 of the process parameter 1 is in particular the value with which the device 4, 5 is to be operated. This is set, for example, on the real device 4 as part of the manufacturing process 2 for the real product 3. The derivation or determination of the setpoint value 6 can take place in a sixth component 24 of a system 14 for data processing.

In step c) 15, the setpoint value 6 is analyzed and an expected actual value 7 of the process parameter 1 is generated, which actually occurs during operation of the real device 4. This takes into account the fact that a setpoint 6 set on a real device 4 is not actually realized by the device 4 in the vast majority of cases.

The analysis of the setpoint value 6 can be carried out by a system 14 for data processing—in this case by a first component 19 of the system 14.

The expected actual value 7 is determined taking into account influencing parameters. Such influencing parameters are, for example, environmental conditions (e.g. temperature, humidity, pressure) of the real device 4, age or operating time of the real device 4, etc.

The expected actual value 7 deviates from the setpoint value 6 or comprises a set of values with a plurality of values. If necessary, a fixed deviation of the expected actual value 7 from the setpoint value 6 is therefore calculated.

In step d) 16, the virtual device 5 is operated with the at least one process parameter 1 as part of a simulation 8. The simulation 8 is carried out in particular by a system 14 for data processing—in this case by a second component 20 of the system 14.

At least the expected actual value 7 is used. In the simulation 8, the virtual device 5 is therefore not operated with the setpoint value 6, but a deviation from the setpoint value 6 that occurs in most cases, which is actually present or can be present on a real device 5, is taken into account.

The simulation 8 therefore takes into account these usual, but previously unconsidered deviations from setpoint values 6 that are present or can occur on real devices 5.

With the proposed method, a more robust simulation 8 of the real manufacturing process 2 can thus be carried out. In particular, instabilities can occur with the selected setpoints 6 due to the actual values 7 occurring on the real device 4, which can only be detected when this possible deviation from the setpoint value 6 is taken into account. These instabilities can then be reduced or avoided by selecting other, i.e. changed, setpoint values 6.

In a further step e1) 17, a product property 9 of a virtual product 10 produced by the simulation 8 that is influenced by the at least one process parameter 1 is determined. If a deviation of the product property 9 from a desired product property 11 is determined, at least steps b) to d) and e1) are repeated at least once with a modified setpoint value 6. Step e1) 17 is carried out by a third component 21 of the system 14 for data processing.

Step e1) 17 is carried out after steps a) to d). The step e1) 17 may represent the condition that at least the steps b) to d) are performed repeatedly with the at least one changed setpoint value 6. According to step c) 15, a new expected actual value 7 is then also generated during the repeated execution.

In particular, steps b) to d) and e1) 17 can be carried out as often as necessary until the product property 9 determined in step e1) 17 corresponds to the desired product property 11 (or lies within its tolerance field).

In a further step e2) 18, the manufacturing costs of the real product 3 and/or the environmental effects that would result from the manufacture of the real product 3 are evaluated as part of the simulation 8, i.e. the operation of the virtual device 5. To minimize the manufacturing costs and/or the environmental effects, at least steps b) to d) and e2) 18 are repeated at least once with a modified setpoint value 6. Step e2) 18 is performed by a fourth component 22 of the system 14 for data processing.

Step e2) 18 is performed after steps a) to d), possibly before, after or simultaneously with step e1) 17. Step e2) 18 may represent the condition that at least steps b) to d) are performed repeatedly with the at least one changed setpoint value 6. According to step c) 15, a new expected actual value 7 is then also generated during the repeated execution.

In particular, steps b) to d) and e2) 18 can be carried out as often as necessary until the manufacturing costs of the real product 3 and/or the environmental effect evaluated in step e2) 18 reach an acceptable or minimum value.

In particular, steps e1) 17 and e2) 18 can be carried out with mutual consideration, i.e. process steps are repeated until satisfactory values are achieved for all the factors mentioned (i.e. product properties, manufacturing costs, environmental effect).

In a step f), a result 12 is determined for the setpoint value 6 in which at least the deviation of the product property 9 determined in step e1) 17 or the manufacturing costs and/or environmental effect determined in step e2) 18 are minimal. This result 12 is used to operate the real device 4.

In particular, step f) represents the conclusion of the method according to steps a) to d) and, if applicable, e1) 17 and/or e2) 18. Step f) is therefore carried out after steps a) to d) and e1) 17 and e2) 18.

The operation of the real device 4 is monitored at least temporarily, e.g. by a fifth component 23 of a system 14 for data processing, whereby the setpoint value 6 used during operation and at least: the actual value 7 that is set on the real device 4; or a product property 9 of the manufactured real product 3; or the manufacturing costs of the real product 3 and/or the environmental effect caused by the manufacture of the real product 3 is recorded.

The explanations for steps a) to d), e1), e2) and f) apply equally here. A corresponding third component 21 and fourth component 22 of the system 14 for data processing are also provided here. In particular, the simulation 8 of the manufacture of the product 10, i.e. the virtual manufacturing process 2 and the virtually manufactured product 10, can be validated and checked and, if necessary, improved by operating the real device 4. In particular, the operating parameters 13 recorded during operation of the real device 4 are compared with the process parameters 1 of the virtual manufacturing process 2, the expected actual values 7, the product properties 9 of the virtual product 10 and the manufacturing costs of the virtual product 10 determined during the simulation 8 and/or the environmental effects caused by the manufacture of the real product 3. From the comparison, the input variables used for the simulation 8 can be validated, i.e. checked, and changed if necessary.

In particular, the real operation is adapted continuously or at intervals on the basis of the operating parameters 13 recorded. The real operation can therefore be changed at any time, i.e. even during the ongoing manufacturing process 2.

In particular, at least one of the recorded operating parameters 13 is taken into account continuously or at intervals for the operation of the virtual device 5. In particular, the recorded operating parameters 13 can be used for a renewed execution of a further simulation 8, so that the results of this further simulation 8 can then be used for real operation.

The individual components 19, 20, 21, 22, 23, 24 can be part of a common system 14 for data processing or can be combined to form a system 14 for data processing (by making the processing data available to each other). The remarks on the data processing system apply in particular to all components 19, 20, 21, 22, 23, 24.

In particular, artificial intelligences are developed and interconnected as part of the method. These are realized by the individual components 19, 20, 21, 22, 23, 24. A so-called recipe manager (sixth component 24) is used to derive and provide suitable setpoint values 6 of the process parameters 1 as part of step b). A so-called digital twin (first component 19) of the at least one real device 4 is used to analyze the setpoint values 6 and to generate an expected actual value 7 of the process parameter 1 according to step c) 15. Furthermore, a (first) process model (second component 20) of the real device 4, i.e. a virtual device 5, is provided so that it is possible to operate the virtual device 5 with the at least one process parameter 1 as part of a simulation 8 of actual parameters 7. In this way, product properties 9 of a virtually manufactured product 10 can be determined as part of step e1) 17 (third component 21). In particular, a controller (a control unit) can also be provided for controlling manufacturing processes 2, including continuous ones, in particular in real time, and a cost model (fourth component 22) for evaluating ecological and economic objectives. The combination of these concepts allows virtual process development and automated improvement or optimization of ecological and/or economic objectives. The consistency of the optimized manufacturing process 2 is ensured in the production of the real product 3 by a pre-trained (second) process model and a controller (fifth component 23). The (second) process model is integrated by means of transfer learning from process development (i.e. from the simulation 8) into production or large-scale series production (i.e. the operation of the series device).

In process development (sixth component), specified product and intermediate product properties in particular are transferred into a corresponding set of setpoint process parameters that produce these product and intermediate product properties as robustly, cost-effectively and sustainably as possible. Based on (personal) experience, empirical knowledge and formal documentation, an initial set of parameters, at least one setpoint value 6, is derived during process development (sixth component), which presumably fulfills the product requirements (step b) of the method).

The so-called recipe manager (sixth component 24) supports the user in particular in converting product properties 9 into a set of setpoint parameters 6. With the help of a so-called digital twin (first component 19), it is possible to estimate in particular which distribution the corresponding actual parameters 7 are subject to on the real device 4 (step c) 15 of the method).

In particular, the expected actual values 7 are virtually transferred from the process model (i.e. as part of the simulation 8, second component 20) into corresponding product properties 9, which allow a comparison with the specification (steps d) 16 and e1) 17 of the method, third component 21).

In particular, the cost model (fourth component 22) can calculate the manufacturing costs using an analytical function and quantify the environmental effects (e.g. CO₂ equivalents in kg) (step e2) of the method).

On this basis, the controller (third component 21 and fourth component 22) can in particular calculate improved setpoint values 6 of the process parameters 1 (step e1) 17 and/or e2) 18 of the method). These can then be transferred back to the digital twin (first component 19) and iteratively improved until no significant improvement in quality or product properties and/or manufacturing costs is achieved, i.e. until the results of the setpoint values 6 according to step f) of the method are available.

Improved or optimized setpoint values 6 of the process parameters 1 can be transferred from the virtual process development to a physical system, i.e. to a real device 4, e.g. in a battery cell production facility. In particular, the digital twin is replaced by a real system which, in addition to the product 3, continuously generates/acquires actual values 7 of the operating parameters 13 on the real device 4.

If the product properties 9 cannot be measured inline, the process model (second component 20) allows their continuous prediction in particular. The process model (second component 20) can be integrated into the real production environment, in particular by means of Transfer Learning, so that it maps the system-specific properties. For this purpose, the process model (second component 20) is pre-trained during process development on a specific system, i.e. the test device (possibly in the laboratory/technical center) and then fine-tuned with new data from production. This can be done either with a reduced learning rate or with partially fixed model parameters.

The estimated product properties 9 (by the third component 21) of the virtual product 10 manufactured by the process model (second component 20) as well as the evaluated manufacturing costs (by the fourth component 22) of measured setpoint parameters are used by the controller in particular for adaptive control of the real manufacturing process 2 and for automated minimization of manufacturing costs.

With an additional, so-called atline analysis (seventh component 25) (which thus takes place on the real device 4 in the real manufacturing process 2), the product properties 9 on continuously manufactured products 3 can be quantified, in particular iteratively, and the prediction of the process model can be validated. Furthermore, training data for improving the simulation 8 (of the process model) can be generated continuously and iteratively in this way.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for determining process parameters for a manufacturing process of a real product, wherein the manufacturing process comprises at least one operation of a real device with at least one process parameter, the method comprising:
providing the real device as a virtual device;
providing a setpoint value of the at least one process parameter;
analyzing the setpoint value and generating an expected actual value of the process parameter that actually occurs during operation of the real device, the expected actual value being determined by taking into account influencing parameters, the expected actual value deviating from the setpoint value or comprising a set of values with a plurality of values; and
operating the virtual device with the at least one process parameter as part of a simulation, wherein at least the expected actual value is used.

2. The method according to claim 1, further comprising determining a product property that is influenced by the at least one process parameter of a virtual product produced by the simulation, wherein, in the event of a determined deviation of the product property from a desired product property at least the steps of providing a setpoint value, analyzing the setpoint value, operating the virtual device and determining a product property are repeated at least once with a modified setpoint value.

3. The method according to claim 1, further comprising carrying out an evaluation of at least manufacturing costs of the real product or of environmental effects resulting from the manufacture of the real product, wherein, in order to minimize at least the manufacturing costs or the environmental effects, at least the steps of providing a setpoint value, analyzing the setpoint value, operating the virtual device and carrying out an evaluation are repeated at least once with a modified setpoint value.

4. The method according to claim 2, further comprising determining a result for the setpoint value, in which at least the deviation of the product property determined or manufacturing costs or environmental effects determined are minimized, wherein this result is used for operating the real device.

5. The method according to claim 4, wherein the operation of the real device is monitored at least intermittently, wherein the setpoint is used during operation and at least: an actual value which is set on the real device, or a product property of the manufactured real product, or at least the manufacturing costs of the real product or the environmental effects caused by the manufacture of the real product are recorded.

6. The method according to claim 5, wherein the real operation is adjusted continuously or at intervals on the basis of the recorded operating parameters.

7. The method according to claim 5, wherein at least one of the detected operating parameters is taken into account continuously or at intervals for the operation of the virtual device.

8. The method according to claim 5, wherein the real device is an experimental device and the result is used for the operation of a real series device, wherein a smaller number of operating parameters are recorded during the operation of the series device than during the operation of the experimental device, wherein the operation of the series device is adapted continuously or at intervals at least also on the basis of the operating parameters recorded on the experimental device.

9. The method according to claim 1, wherein the manufacturing process comprises a plurality of successive manufacturing steps carried out on different devices, and wherein at least some of the manufacturing steps are carried out as part of continuous manufacturing.

10. The method according to claim 1, wherein the real product is at least one component of a battery cell and the real device is designed for manufacturing at least this component.
